(19) United States
(12) Patent Application Publication
(10) Pub. No.: US 2008/0164836 A1
(43) Pub. Date: Jul. 10, 2008

(54) Static Frequency Converter with Automatic Function for Optimizing Magnetic Flux and Minimizing Losses in Electric Induction Motors

(76) Inventors: Sebastiao Lauro Nau, Santa Catarina (BR); Alexandre Postol Sobrinho, Santa Catarina (BR); Siegfried Kreutzfeld, Santa Catarina (BR); Hugo Gustavo Gomez Mello, Santa Catarina (BR)

Correspondence Address: CANTOR COLBURN, LLP, 20 Church Street, 22nd Floor, Hartford, CT, 06103, US

(21) Appl. No.: 10/569,775

(22) PCT Filed: May 24, 2004
(86) PCT No.: PCT/BR2004/000074

§ 371 Date: Sep. 26, 2007

(30) Foreign Application Priority Data
Jan. 5, 2004 (BR) PI 0400456-6

(51) Int. Cl. H02P 23/14

(52) U.S. Cl. 318/807; 318/767

(57) ABSTRACT

“STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, having an automatic function for regulating and controlling magnetic flux in the motor in function of the motor's operating frequency, such that the motor operates with ideal magnetic flux and consequently with less total losses.

This Patent Application refers to a static frequency converter with automatic function for optimizing magnetic flux and minimizing losses in electric induction motors.

In the present case, the function is previously defined according to the electromechanical features of the induction motors to be activated by the converter. Based on the information contained in the function, the converter automatically controls and regulates the electric voltage/frequency ratio such that the motor operates with ideal magnetic flux and with the least possible losses.

According to the prior art, a self-ventilated induction motor (which is the one most commonly used in industrial applications), when activated by a static frequency converter (also commercially known simply as frequency inverter) presents different temperature elevations due to the rotation.

In low rotations, for a load with constant torque, the motor losses remain practically constant, however, the ventilation is reduced due to the reduction of the motor speed and consequently of the speed of the ventilator incorporated to the motor shaft, and this leads to an increase in the motor temperature. To prevent this overheating and to keep the motor's temperature elevation within its thermal class, the technique currently used is that of providing the motor with an independent ventilation system, or overdimensioning the motor.

Both solutions present disadvantages for they considerably increase the motor's cost, in addition to increasing its size and weight.

In view of this prior art, this Patent Application was developed, which is the result of a study on the behavior of losses in induction motors under frequency variation and magnetic flux.

In this context, the proposed solution is based on the modification of the static frequency converter's features so as to incorporate a function to automatically vary the electric voltage/frequency ratio, and consequently the magnetic flux in the motor for each operating frequency value so as to minimize the motor's total losses. This optimizing function, that is, for reduction of losses, has a predefined behavior due to the features of the motors to be activated.

The PWM (Pulse Width Modulation) type static frequency converters, modulated by pulse width, basically present two forms of control: scalar and vectorial (with or without speed sensor).

The scalar control is that which imposes a determined voltage/frequency ratio on the motor, aiming at keeping a constant ratio, that is, the magnetic flux constant in the motor. This ratio is, however, constant regardless of the frequency at which the motor is operating.

The power losses in ferromagnetic material that make up the stator and the induction rotor increase as the magnetic flux (which is proportional to the voltage/frequency ratio (V/f)) and the frequency increase.

The ideal would be for the converter to provide the motor with the best voltage/frequency ratio (V/f) such that the magnetic flux in the motor caused the least total losses in the motor. Apart from losses in the ferromagnetic material, there are also losses caused by Joule effect in the motor windings due to the electric current.

The magnetic flux contributes towards the management of these losses. The more saturated the motor, that is, with a high magnetic flux, the greater will be the magnetizing current and the greater also will be the losses due to the Joule effect caused by this current.

On the other hand, as the magnetic flux increases, for the same load torque, the load current in the motor windings reduce, also reducing losses caused by Joule effect due to the load current.

Thus, one notices that the magnetic flux positively and negatively influences the generation of losses in the motor, although in different proportions.

The vectorial control carries out a vectorial breakdown of the motor current in the vectors that represent the torque and magnetic flux in the motor, in such a way as to enable regulation independently of the torque and flux.

Likewise in the scalar control, for a constant torque load, the vectorial control keeps the magnetic flux constant in the entire frequency range of operation for the motor.

Thus, the vectorial control also keeps the losses constant; there is no regulation of the percentage of magnetic flux and therefore no minimization of the motor's losses.

This invention is precisely in function of the converter that automatically controls and regulates the motor's magnetic flux for a condition of minimal losses.

The function was developed based on the electromechanical features of the motors, and was later implemented in the converter.

The function indicates the ideal magnetic flux of the motor for each operating frequency, that is, the flux condition in which the motor presents the smallest total losses.

This function may be presented by an n polynomial. Usually, the polynomial has order of 1, 2 or 3.

Take for instance the case of a second-order polynomial. Therefore, the function that determines the ideal flux value in p.u. (per unit) is given by:

Flux (p.u.)=A.f²+B.f+C, where A, B and C are the function's coefficients that depend on the motor's electromechanical features, and f is the ratio of the frequency desired to operate the motor to the motor's nominal frequency, that is, f is taken in p.u.

### EXAMPLE

For a motor with nominal frequency of 60 Hz and operation in 6 Hz, the f variable is equal to 6/60, that is, f=0.1. Supposing that for this example A=0, B=3 and C=1.5, the ideal magnetic flux in p.u. would be equal to 1.2. This means that when the motor is operating at 6 Hz, the converter will supply the motor with an electric voltage/frequency ratio sufficient for the magnetic flux in the motor to be 120% of the nominal magnetic flux value.

For this condition, the line of motors exemplified will present minimal losses and the temperature elevation of the motor will not exceed the maximum values for the thermal class of the insulating materials.

In the converter, the programming of parameters is done via machine-man interface (MMI). The function of ideal flux is activated by choosing a specific parameter. Before the adjustment of parameters required for the motor's operation, it is important to check if the converter's supply voltage is within the allowable range (+10%/−15%).

The motor's features, such as: voltage, current, frequency, speed, power and ventilation, are programmed in different parameters of the inverter. However, the function of ideal flux for minimizing the motor's losses was implemented in a specific parameter. In this parameter, there are three conditions for the motor's ventilation: 0 corresponds to the self-ventilated motor, 1 corresponds to the motor with independent ventilation, and 2 corresponds to the special motor, that is, the motor that will operate with the function of ideal flux and, consequently, with minimal losses.

1. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, comprising an automatic function that regulates and controls the magnetic flux in the motor in function of its operating frequency, such that the motor operates with ideal magnetic flux and consequently with lesser total losses.

2. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, according to claim 1, further comprising automatically supplying the induction motor with an ideal, electric voltage/frequency ratio for each motor operating frequency, such that the motor operates with ideal magnetic flux and consequently with less losses.

3. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, according to claim 1, further comprising internally in its regulating and controlling software one or more curves that relate ideal magnetic flux in function of the frequency, as per the electromechanical specification of the induction motors to be activated.

4. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, according to claim 1, further comprising a specific parameter for automatic evaluation of ideal flux.

5. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, according to claim 1, further comprising enabling the electric induction motor to operate with nominal torque from zero frequency up to a base (nominal) frequency without need to overdimension the motor and to reduce load torque.

6. “STATIC FREQUENCY CONVERTER WITH AUTOMATIC FUNCTION FOR OPTIMIZING MAGNETIC FLUX AND MINIMIZING LOSSES IN ELECTRIC INDUCTION MOTORS”, according to claim 1, where a function that determines a value of ideal flux in p.u. (per unit) is given by: Flux (p.u.)=A.f²+B.f.+C, where A, B, C are the function's coefficients that depend on the motor's electromechanical features, and f is a ratio of the frequency desired to operate the motor to the motor nominal frequency, where f is taken in p.u.
